(19) United States
(12) Patent Application Publication
(10) Pub. No.: US 2025/0340155 A1
(43) Pub. Date: Nov. 6, 2025

(54) TILTABLE CHILD SEAT DEVICE

(71) Applicant: Natalie Burris, Shreveport, LA (US)

(72) Inventor: Natalie Burris, Shreveport, LA (US)

(21) Appl. No.: 18/653,667

(22) Filed: May 2, 2024

(51) Int. Cl. B60N 2/28

(52) U.S. Cl. CPC B60N 2/2875; B60N 2/2869

(57) ABSTRACT

A tiltable child seat device includes a mounting base having a top section rotatably attached to a bottom section and the mounting base has a plurality of stops. A base locking mechanism is movably integrated into the bottom section to engage a respective one of the plurality of stops thereby inhibiting the top section from rotating. A car seat is provided with a car seat base pivotally disposed in the top section and a seat attached to the car seat base to accommodate a child. The car seat is pivotal in either direction in the mounting base to facilitate a mother to breastfeed the child while the mother is sitting next to the car seat. The car seat has a plurality of stops integrated into the car seat base. A car seat locking mechanism is movably integrated into the mounting base to engage a respective stop in the car seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to child seat devices and more particularly pertains to a new child seat device for facilitating a mother to breastfeed a child seated in a car seat. The device includes a mounting base which has a top portion rotatably disposed in a bottom section and a base locking mechanism which locks the top portion at a desired angle of rotation in the bottom section. The device includes a car seat that is pivotally attached to the top portion of the mounting base and a car seat locking mechanism for retaining the car seat at a preferred angle on the mounting base. In this way a mother can breastfeed a child seated in the car seat while the mother is seated next to the car seat.

### (2) Description of Related Art Including Information Disclosed Under 37 CFR 1.97 and 1.98

The prior art relates to child seat devices including a variety of child car seat devices that each at least includes a base upon which a car seat is pivotally disposed and a child car seat device that includes a car seat that includes cammed arm rests for rotating the arm rests into a desired orientation and a child car seat device that includes a track and a car seat slidably attached to the track for sliding the car seat back and forth. In no instance does the prior art disclose a child car seat device that includes a mounting base that has a top portion rotatably integrated into a bottom portion and a child car seat pivotally attached to the top portion which can be pivoted back and forth to facilitate a mother to breastfeed a child seated in the car seat.

### BRIEF SUMMARY OF THE INVENTION

An embodiment of the disclosure meets the needs presented above by generally comprising a mounting base having a top section rotatably attached to a bottom section and the mounting base has a plurality of stops. A base locking mechanism is movably integrated into the bottom section to engage a respective one of the plurality of stops thereby inhibiting the top section from rotating. A car seat is provided with a car seat base pivotally disposed in the top section and a seat attached to the car seat base to accommodate a child. The car seat is pivotal in either direction in the mounting base to facilitate a mother to breastfeed the child while the mother is sitting next to the car seat. The car seat has a plurality of stops integrated into the car seat base. A car seat locking mechanism is movably integrated into the mounting base to engage a respective stop in the car seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a tiltable child seat device according to an embodiment of the disclosure.

FIG. 2 is a front phantom view of an embodiment of the disclosure showing a car seat in an upright position.

FIG. 3 is a front phantom view of an embodiment of the disclosure showing a car seat in a tilted position.

FIG. 4 is a left side phantom view of an embodiment of the disclosure.

FIG. 5 is a bottom phantom view of an embodiment of the disclosure.

FIG. 6 is a back phantom view of an embodiment of the disclosure.

FIG. 7 is a cut-away view taken from circle 7 of FIG. 4 of an embodiment of the disclosure.

FIG. 8 is a left side view of an embodiment of the disclosure showing a car seat in a tilted position.

FIG. 9 is a magnified detail view taken from circle 9 of FIG. 4 of an embodiment of the disclosure.

FIG. 10 is a perspective in-use view of an embodiment of the disclosure.

### DETAILED DESCRIPTION OF THE INVENTION

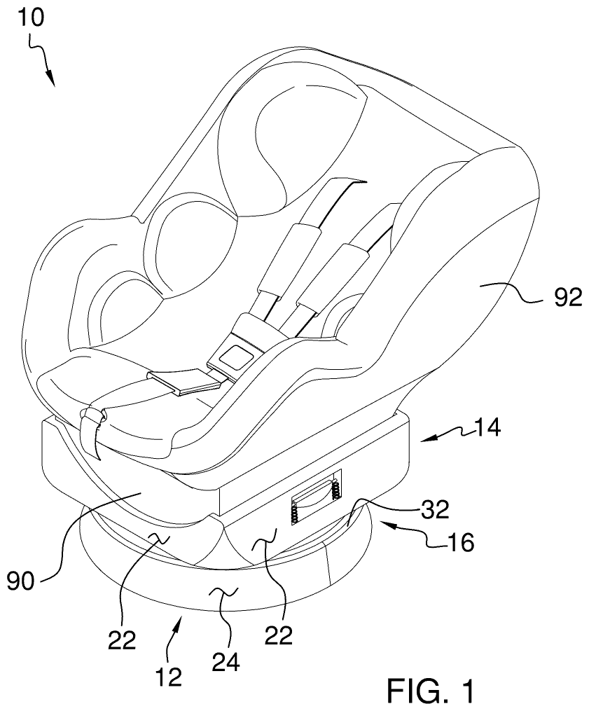

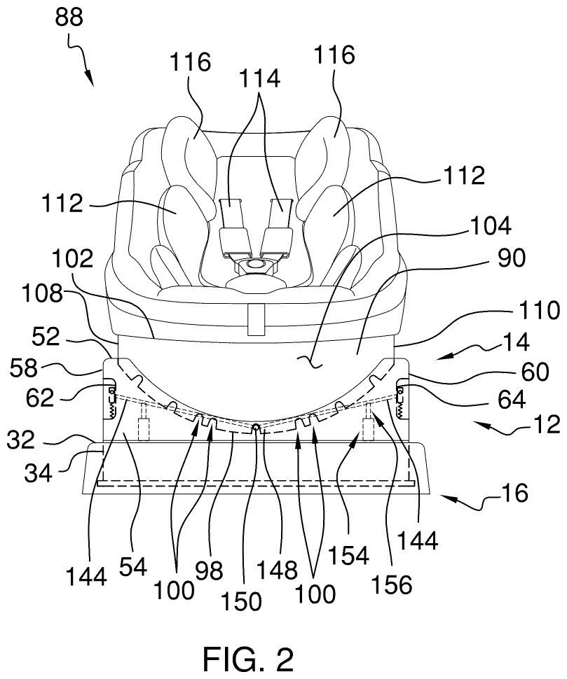

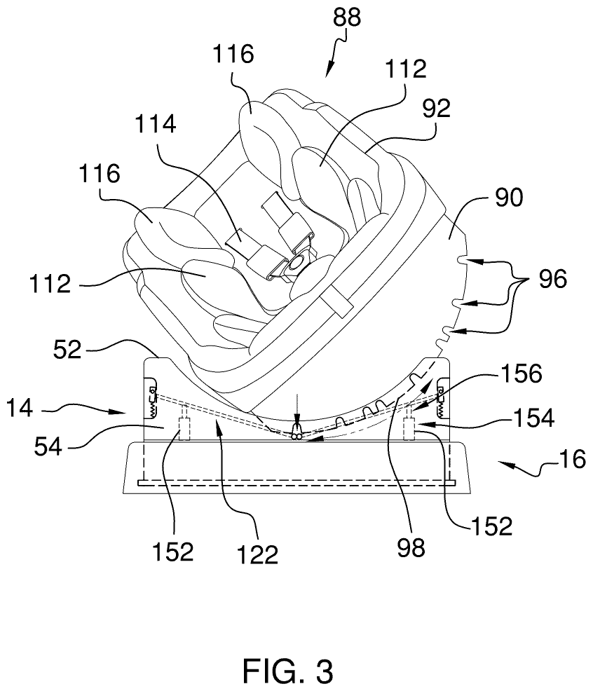

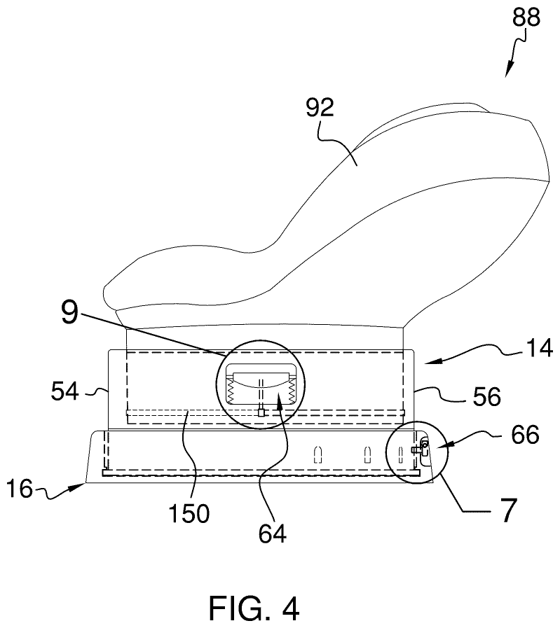

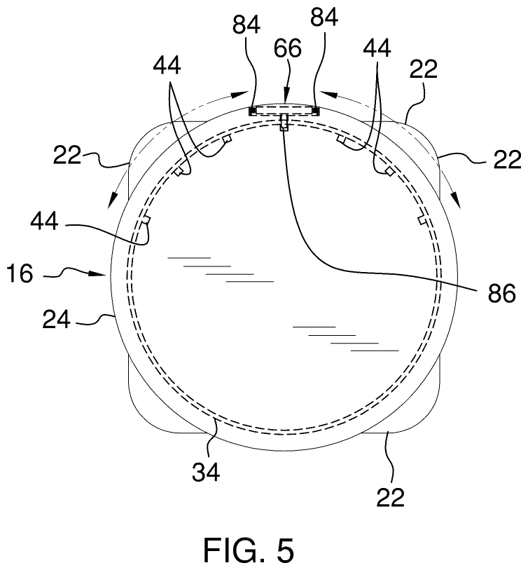

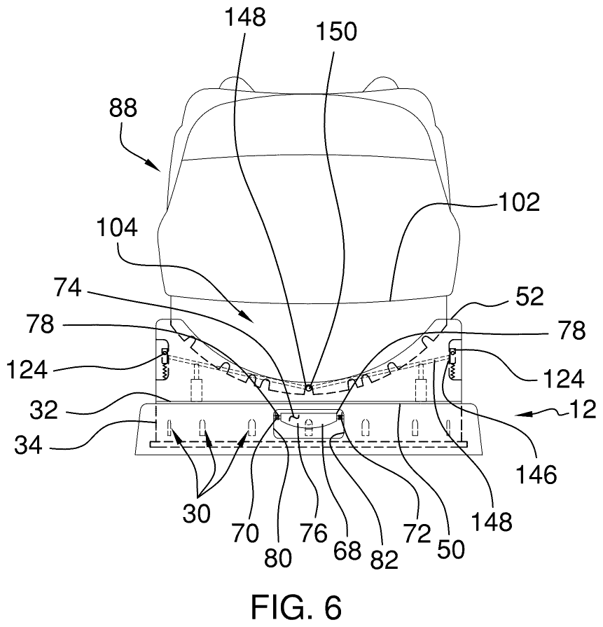

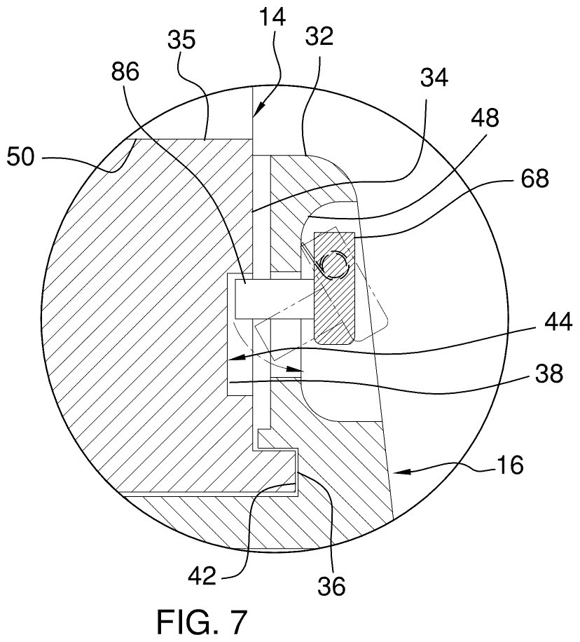

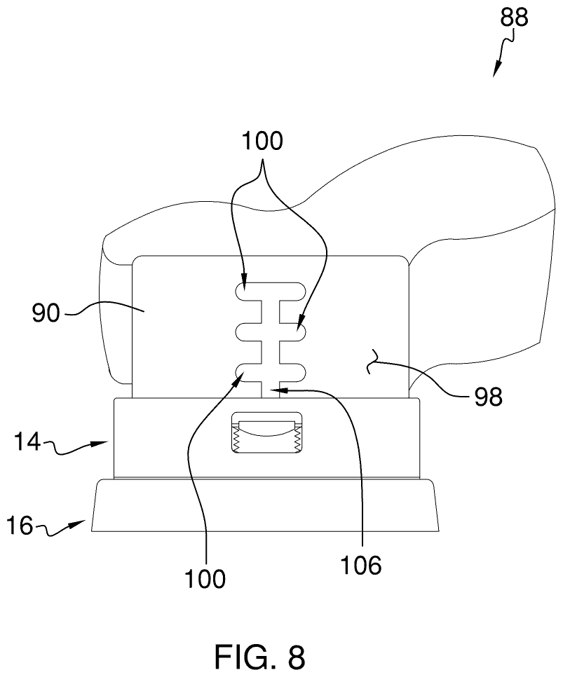

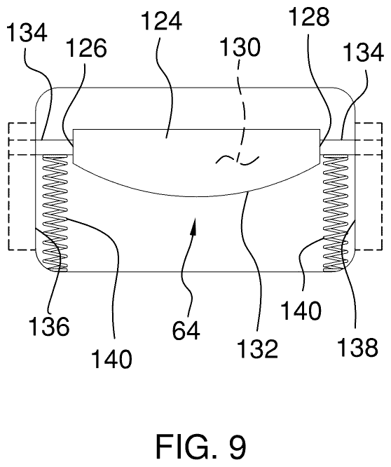

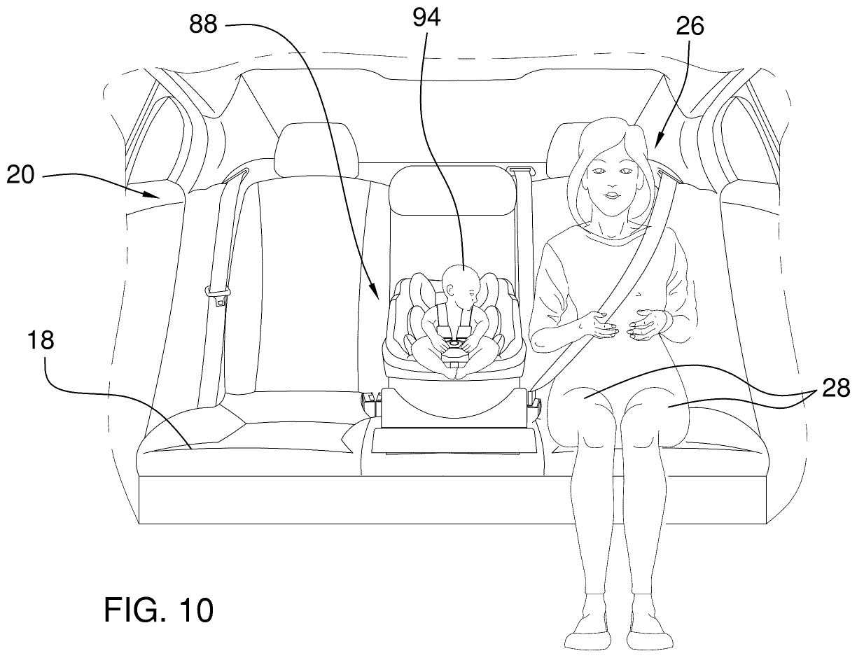

With reference now to the drawings, and in particular to FIGS. 1 through 10 thereof, a new child seat device embodying the principles and concepts of an embodiment of the disclosure and generally designated by the reference numeral 10 will be described.

As best illustrated in FIGS. 1 through 10, the tiltable child seat device 10 generally comprises a mounting base 12 which comprises a top section 14 that is rotatably attached to a bottom section 16 such that the top section 14 is rotatable about a vertical axis on the bottom section 16. The bottom section 16 of the mounting base 12 is positionable on a seat 18 in a vehicle 20 having the top section 14 extending upwardly from the seat 18. The vehicle 20 may be a passenger vehicle, a cargo vehicle or any other type of motorized vehicle that his commonly driven on public roadways. Additionally, the seat 18 may be a back seat in the vehicle 20 or other seat upon which a child car seat would typically be positioned.

The top section 14 has a plurality of outer surfaces 22 which are perpendicularly oriented with each other such that the top section 14 has a rectilinear shape. The bottom section 16 has an outer surface 24 that is continuously arcuate such that the bottom section 16 has a circular shape. In this way the mounting base 12 facilitates a mother 26 to sit next to the bottom section 16 without having the outer surfaces 22 of the top section 14 striking the mother's leg 28 when the top section 14 is rotated. The mounting base 12 has a plurality of stops 30 and the bottom section 16 has a top side 32 that is open. Furthermore, the mounting base 12 includes a disk 34 that is rotatably positioned within the bottom section 16 such that an upper surface 35 of the disk 34 is aligned with the top side 32 of the bottom section 16. The disk 34 has a lip 36 extending outwardly from an outside surface 38 of the disk 34 which is aligned with a lower surface 40 of the disk 34. Furthermore, the lip 36 extends into a groove 42 which is integrated into the bottom section 16 thereby inhibiting the disk 34 from being lifted outwardly from the bottom section 16.

The disk 34 has a plurality of notches 44 each extending into an exterior surface 46 of the disk 34 such that the plurality of notches 44 defines the plurality of stops 30. The notches 44 are evenly spaced apart from each other and are distributed partially around a circumference of the disk 34. The bottom section 16 has a recess 48 extending into the outer surface 24 of the bottom section 16 and the top section 14 has a bottom wall 50 which is attached to the upper surface 35 of the disk 34. Additionally, each of the outer surfaces 22 of the top section 14 has a length which is greater than a diameter of the bottom section 16 such that an intersection between respective outer surfaces 22 of the top section 14 extends outwardly beyond the outer surface 24 of the bottom section 16. The top section 14 has an upper end 52 that is open into an interior of the top section 14 and the plurality of outer surfaces 22 of the top section 14 has a front side 54, a back side 56, a first lateral side 58 and a second lateral side 60. Additionally, each of the front side 54 and the back side 56 is scalloped to curve downwardly toward the bottom section 16. The top section 14 has a first recess 62 extending into the first lateral side 58 of the outer surfaces 22 of the top section 14. The top section 14 has a second recess 64 extending into the second lateral side 60 of the outer surfaces 22 of the top section 14.

A base locking mechanism 66 is provided and the base locking mechanism 66 is movably integrated into the bottom section 16 of the mounting base 12. The base locking mechanism 66 is biased into a locking condition having the base locking mechanism 66 engaging a respective one of the plurality of stops 30 in the mounting base 12 thereby inhibiting the top section 14 from being rotated. The base locking mechanism 66 is urgeable into an unlocking condition having the base locking mechanism 66 being disengaged from the plurality of stops 30 thereby enabling the top section 14 to be rotated.

The base locking mechanism 66 comprises a base handle 68 that has a first end 70, a second end 72, a forward surface 74 and a lower surface 76. The lower surface 76 curves downwardly between each of the first end 70 and the second end 72 to enable the base handle 68 to be gripped. The base handle 68 has a pair of pins 78 each disposed on a respective one of the first end 70 and the second end 72. Additionally, each of the pair of pins 78 extends into a respective one of a first lateral bounding surface 80 and a second lateral bounding surface 82 of the recess 48 in the outer surface 24 of the bottom section 16 of the mounting base 12. In this way the base handle 68 is pivotally retained in the recess 48 in the outer surface 24 of the bottom section 16.

The base locking mechanism 66 includes a pair of biasing members 84 and each of the pair of biasing members 84 is positioned around a respective one of the pair of pins 78. Each of the pair of biasing members 84 biases the base handle 68 into a first position having the forward surface 76 lying on a vertical plane. Conversely, the base handle 68 is pivotable into a second position having the forward surface 76 lying on an angled plane and having the lower surface 76 extending outwardly from the recess 48 in the outer surface 24 of the bottom section 16 of the mounting base 12 when the base handle 68 is gripped. The base locking mechanism 66 includes a finger 86 which is attached to and extends away from the forward surface 76. The finger 86 engages a respective one of the plurality of notches 44 in the disk 34 when the base handle 68 is biased into the first position thereby inhibiting the disk 34 from being rotated. Conversely, the finger 86 is displaced from the respective notch 44 when the base handle 68 is pivoted into the second position thereby enabling the disk 34 to be rotated.

A car seat 88 is provided which has a car seat base 90 which is pivotally disposed in the top section 14 of the mounting base 12 and a seat 92 which is attached to the car seat base 90 to accommodate a child 94. The car seat 88 is pivotal in either direction in the mounting base 12 to position the child 94 at a preferred orientation to facilitate the mother 26 to breastfeed the child 94 while the mother 26 is sitting next to the car seat 88. Furthermore, the child 94 can remain seated in the seat 92 for enhancing safety of the child 94 when the mother 26 and the child 94 are travelling in the vehicle 20. The car seat 88 has a plurality of stops 96 each being integrated into the car seat base 90 and the car seat base 90 has a rounded surface 98 which extends into the top section 14 of the mounting base 12. The car seat base 90 has a series of notches 100 each being integrated into the rounded surface 98 such that the series of notches 100 defines the plurality of stops 96 in the car seat base 90.

The car seat base 90 has a top surface 102 and an outside surface 104 extending between the top surface 102 of the car seat base 90 and the rounded surface 98. Furthermore, the rounded surface 98 is convexly arcuate with respect to the top surface 102 of the car seat base 90. The top surface 102 of the car seat base 90 is planar and the outside surface 104 of the car seat base 90 is perpendicularly oriented with the top surface 102 of the car seat base 90. The rounded surface 98 of the car seat base 90 has a channel 106 that is recessed into the rounded surface 98 and the channel 106 extends between a first lateral side 108 and a second lateral side 110 of the outside surface 104 of the car seat base 90. Additionally, the channel 106 is oriented to bisect the rounded surface 98. Each of the series of notches 100 in the rounded surface 98 extends along a line that is perpendicularly oriented with the channel 106 having each of the series of notches 100 extending across the channel 106. Additionally, the series of notches 100 are spaced apart from each other and are distributed along a full length of the channel 106.

The car seat base 90 is oriented in the top section 14 of the mounting base 12 having the channel 106 extending along a line which extends between the first lateral side 58 and the second lateral side 60 of the outer surfaces 22 of the top section 14. Furthermore, the car seat 88 is pivotal in the top section 14 of the mounting base 12 along the channel 106. The seat 92 of the car seat 88 includes a plurality of cushions 112 and a securing harness 114; the child 94 can be seated on the cushions 112 and the securing harness 114 extends over the child 94 for securing the child 94 in the seat of the car seat 88. The plurality of cushions 112 includes a pair of head cushions 116 which are spaced apart from each other and are located proximate a top end 118 of the seat 92 of the car seat 88. In this way the pair of head cushions 116 can be positioned on either side of the child's head 120 for inhibiting the child's head 120 from tilting from side to side when the car seat 88 is pivoted in the mounting base 12.

A car seat locking mechanism 122 is provided and the car seat locking mechanism 122 is movably integrated into the mounting base 12. The car seat locking mechanism 122 is biased into a locking condition having the car seat locking mechanism 122 engaging a respective one of the plurality of stops 96 in the car seat 88. In this way the car seat 88 is inhibited from being pivoted in the mounting base 12. Conversely, the car seat locking mechanism 122 is urgeable into an unlocking condition having the car seat locking mechanism 122 being displaced from the respective stop 96 in the car seat 88. In this way the car seat 88 is enabled to be pivoted in the mounting base 12.

The car seat locking mechanism 122 includes a pair of seat handles 124 which each has a first end 126 and a second end 128 and a forward surface 130 and a lower surface 132. The lower surface 132 of each of the seat handles 124 curves downwardly between each of the first end 126 and the second end 128 of a respective seat handle 124. The seat handles 124 each has a pair of pins 134 which are each disposed on a respective one of the first end 126 and the second end 128 of a respective seat handle 124. Each of the pair of pins 134 of the seat handles 124 extends into a respective one of a first lateral bounding surface 136 and a second lateral bounding surface 138 of a respective one of the first recess 62 and the second recess 64 in the outer surfaces 22 of the top section 14 of the mounting base 12. In this way the seat handles 124 are slidably retained in the respective first recess 62 and second recess 64 such that one of the pair of seat handles 124 is accessible to the mother 26 regardless of which side of the car seat 88 the mother 26 is situated.

The car seat locking mechanism 122 includes a plurality of biasing members 140 and each of the plurality of biasing members 140 of the car seat locking mechanism 122 is positioned between a respective one of the pair of pins 134 on respective one of the pair of seat handles 124 and a lower bounding surface 142 of the respective first recess 62 and the second recess 64. Each of the plurality of biasing members 140 of the car seat locking mechanism 122 biases the respective seat handle 124 into a first position having the lower surface 132 of each of the pair seat handles 124 being spaced upwardly from the lower bounding 142 surface of the respective first recess 62 or the second recess 64. Conversely, each of the pair of seat handles 124 is urgeable downwardly into a second position having the lower surface 132 of the pair of seat handles 124 travelling toward the lower bounding surface 142 of the respective first recess 62 or the second recess 64.

The car seat locking mechanism 122 includes a pair of rods 144 and each of the pair of rods 144 has a primary end 146 which is coupled to the forward surface 130 of a respective one of the pair of seat handles 124 having each of the pair of rods 144 being positioned in the top section 14 of the mounting base 12. Each of the pair of rods 144 is oriented to angle downwardly from the forward surface 130 of the respective seat handle 124 having each of the pair of rods 144 extending through the channel 106 in the rounded surface 98 of the car seat base 90. In this way the pair of rods 144 are inhibited from abutting the car rounded surface 98 of the car seat base 90 when the pair of seat handles 124 are biased into the first position. Additionally, a secondary end 148 of each of the pair of rods 144 is centrally located in the top section 14 of the mounting base 12.

The car seat locking mechanism 122 includes a member 150 that is attached to the secondary end 148 of each of the pair of rods 144 such that the member 150 is perpendicularly oriented with the pair of rods 144. The member 150 is positioned in a respective one of the plurality of notches 100 in the rounded surface 98 of the car seat base 90 when the pair of seat handles 124 is in the first position. In this way the member 150 inhibits the car seat base 90 from being pivoted in the top section 14 of the mounting base 12. The member 150 is urged downwardly out of the respective notch 100 in the rounded surface 98 when either of the pair of seat handles 124 is urged into the second position thereby enabling the car seat base 90 to be pivoted in the top section 14 of the mounting base 12. The plurality of notches 100 in the rounded surface 98 are arranged to enable the car seat base 90 to be oriented at a variety of angles with respect to a vertical axis which might range between approximately 15.0 degrees and 45.0 degrees of deflection from the vertical axis.

The car seat locking mechanism 122 includes a pair of supports 152 and each of the pair of supports 152 includes a lower section 154 which slidably receives a second section 156 such that each of the pair of supports 152 has a telescopically adjustable height. The upper section 156 of each of the pair of support is biased to extend upwardly from the lower section 154 of a respective support 152. The lower section 154 of each of the pair of supports 152 is attached to the bottom wall 50 of the top section 14 of the mounting base 12 such that each of the pair of supports 152 is positioned within the top section 14. Additionally, the upper section 156 of each of the pair of supports 152 is attached to a respective one of the pair of rods 144.

The upper section 156 of each of the supports 152 is compressed downwardly into the lower section 154 of a respective support 152 when either of the pair of seat handles 124 is urged into the second position. Conversely, the upper section 156 of each of the supports 152 biases the respective rod 144 upwardly thereby positioning the member 150 in a respective one of the plurality of notches 100 in the rounded surface 98 of the car seat base 90 when the pair of seat handles 124 is biased into the first position. Each of the pair of supports 152 may comprise a hydraulic piston or a pneumatic piston or other type of compressible biasing device that can not only inhibit the respective rod 144 from deflecting laterally but also enable the respective rod 144 to move upwardly and downwardly.

In use, the mounting base 12 is positioned on the seat in the vehicle 20 and the child 94 is secured in the seat of the car seat 88 with the harness 114. The base locking mechanism 66 is urged into the unlocked condition to facilitate the car seat 88 to be rotated on the mounting base 12 and the car seat locking mechanism 122 is urged into the unlocking condition to facilitate the car seat 88 to be pivoted toward the mother 26. In this way the child 94 in the car seat 88 can be oriented at a preferred orientation to enable the mother 26 to breastfeed the child 94 when the mother 26 is seated next to the car seat 88 and the child 94 is secured in the car seat 88. Thus, the mother 26 can breastfeed the child 94 while the child 94 is still secured in the car seat 88 thereby protecting the child 94 from injury in the event of a collision while the vehicle 20 is in motion.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A tiltable child seat device for enabling a mother to breastfeed a child while the mother and child are seated in a vehicle, said device comprising:
a mounting base comprising a top section being rotatably attached to a bottom section such that said top section is rotatable about a vertical axis on said bottom section, said bottom section of said mounting base being positionable on a seat in a vehicle having said top section extending upwardly from the seat, said top section having a plurality of outer surfaces being perpendicularly oriented with each other such that said top section has a rectilinear shape, said bottom section having an outer surface being continuously arcuate such that said bottom section has a circular shape wherein said mounting base is configured to facilitate a mother to sit next to said bottom section without having said outer surfaces of said top section striking the mother's leg when said top section is rotated, said mounting base having a plurality of stops;
a base locking mechanism being movably integrated into said bottom section of said mounting base, said base locking mechanism being biased into a locking condition having said base locking mechanism engaging a respective one of said plurality of stops in said mounting base thereby inhibiting said top section from being rotated, said base locking mechanism being urgeable into an unlocking condition having said base locking mechanism being disengaged from said plurality of stops thereby enabling said top section to be rotated;
a car seat having a car seat base being pivotally disposed in said top section of said mounting base and a seat being attached to said car seat base wherein said seat is configured to accommodate a child, said car seat being pivotal in either direction in said mounting base wherein said car seat is configured to position the child at a preferred orientation to facilitate a mother to breastfeed the child while the mother is sitting next to said car seat such that the child can remain seated in said seat for enhancing safety of the child when the mother and the child are travelling in the vehicle, said car seat having a plurality of stops each being integrated into said car seat base; and
a car seat locking mechanism being movably integrated into said mounting base, said car seat locking mechanism being biased into a locking condition having said car seat locking mechanism engaging a respective one of said plurality of stops in said car seat thereby inhibiting said car seat from being pivoted in said mounting base, said car seat locking mechanism being urgeable into an unlocking condition having said car seat locking mechanism being displaced from said respective stop in said car seat thereby enabling said car seat to be pivoted in said mounting base.

2. The device according to claim 1, wherein:
said bottom section has a top side which is open;
said mounting base includes a disk being rotatably positioned within said bottom section such that an upper surface of said disk is aligned with said top side of said bottom section;
said disk has a lip extending outwardly from an outside surface of said disk which is aligned with a lower surface of said disk;
said lip extends into a groove which is integrated into said bottom section thereby inhibiting said disk from being lifted outwardly from said bottom section;
said disk has a plurality of notches each extending into an exterior surface of said disk such that said plurality of notches defines said plurality of stops;
said plurality of notches is evenly spaced apart from each other and is distributed partially around a circumference of said disk;
said top section has a bottom wall which is attached to said upper surface of said disk;
each of said outer surface of said top section having a length which is greater than a diameter of said bottom section such that an intersection between respective outer surfaces of said top section extends outwardly beyond said outer surface of said bottom section;
said top section has an upper end being open into an interior of said top section;
said plurality of outer surfaces of said top section has a front side and a back side and a first lateral side and a second lateral side; and
each of said front side and said back side is scalloped to curve downwardly toward said bottom section.

3. The device according to claim 1, wherein:
said bottom section of said mounting base has a recess extending into an outer surface of said bottom section;
said base locking mechanism includes a base handle having a first end and a second end and a forward surface and a lower surface;
said lower surface curves downwardly between each of said first end and said second end wherein said lower surface is configured to enable said base handle to be gripped;
said base handle has a pair of pins each being disposed on a respective one of said first end and said second end; and
each of said pair of pins extends into a respective one of a first lateral bounding surface and a second lateral bounding surface of said recess in said outer surface of said bottom section of said mounting base for pivotally retaining said base handle in said recess in said outer surface of said bottom section.

4. The device according to claim 3, wherein
said mounting base includes a disk being rotatably positioned within said bottom section;
said disk has a plurality of notches each extending into an exterior surface of said disk;
said base locking mechanism includes a pair of biasing members;
each of said pair of biasing members is positioned around a respective one of said pair of pins;
each of said pair of biasing members biases said base handle into a first position having said forward surface lying on a vertical plane;
said base handle is pivotable into a second position having said forward surface lying on an angled plane and having said lower surface extending outwardly from said recess in said outer surface of said bottom section of said base when said base handle is gripped;
said base locking mechanism includes a finger being attached to and extending away from said forward surface;
said finger engages a respective one of said plurality of notches in said in said disk when said base handle is biased into said first position thereby inhibiting said disk from being rotated; and
said finger is displaced from said respective notch when said base handle is pivoted into said second position thereby enabling said disk to be rotated.

5. The device according to claim 1, wherein:
said car seat base has a rounded surface which extends into said top section of said mounting base;
said car seat base has a series of notches each being integrated into said rounded surface such that said series of notches defines said plurality of stops in said car seat base;
said car seat base has a top surface and an outside surface extending between said top surface of said car seat base and said rounded surface;
said rounded surface is convexly arcuate with respect to said top surface of said car seat base;
said top surface of said car seat base is planar;
said outside surface of said car seat base is perpendicularly oriented with said top surface of said car seat base;
said rounded surface of said car seat base has a channel being recessed into said rounded surface;
said channel extends between a first lateral side and a second lateral side of said outside surface of said car seat base;
said channel is oriented to bisect said rounded surface;
each of said series of notches in said rounded surface extends along a line being perpendicularly oriented with said channel having each of said series of notches extending across said channel;
said series of notches are spaced apart from each other and are distributed along a full length of said channel;
said car seat base is oriented in said top section of said mounting base having said channel extending along a line extending between a first lateral side and a second lateral side of an outer surface of said top section; and
said car seat is pivotal in said top section of said mounting base along said channel.

6. The device according to claim 1, wherein:
said seat of said car seat includes a plurality of cushions and a securing harness wherein said car seat is configured to have the child seated on said cushions and having said securing harness extending over the child for securing the child in said seat of said car seat; and
said plurality of cushions includes a pair of head cushions being spaced apart from each other and being located proximate a top end of said seat of said car seat wherein said pair of head cushions is configured to be positioned on either side of the child's head for inhibiting the child's head from tilting from side to side when said car seat is pivoted in said mounting base.

7. The device according to claim 5, wherein:
said top section has a first recess extending into said first lateral side of said outer surfaces of said top section; and
said top section has a second recess extending into said second lateral side of said outer surfaces of said top section;
said car seat locking mechanism includes a pair of seat handles;
each of said pair of seat handles has a first end and a second end and a forward surface and a lower surface;
said lower surface of each of said seat handles curves downwardly between each of said first end and said second end of a respective seat handle;
each of said pair of seat handles has a pair of pins each being disposed on a respective one of said first end and said second end of a respective seat handle;
each of said pair of pins of said seat handles extends into a respective one of a first lateral bounding surface and a second lateral bounding surface of a respective one of said first recess and said second recess in said outer surface of said top section of said mounting base for slidably retaining said seat handles in said respective first recess and second recess wherein one of said pair of seat handles is configured to be accessible to the mother regardless of which side of said car seat the mother is situated;
said car seat locking mechanism includes a pair of rods; and
each of said pair of rods extends through said channel in said rounded surface of said car seat base thereby inhibiting said pair of rods from abutting said car rounded surface of said car seat base when said pair of seat handles are biased into said first position.

8. The device according to claim 7, wherein:
each of said pair of rods has a primary end being coupled to said forward surface of a respective one of said pair of seat handles having each of said pair of rods being positioned in said top section of said mounting base; and
each of said pair of rods is oriented to angle downwardly from said forward surface of said respective seat handle having a secondary end of each of said pair of rods being centrally located in said top section of said mounting base.

9. The device according to claim 8, wherein:
said car seat locking mechanism includes a member being attached to said secondary end of each of said pair of rods such that said member is perpendicularly oriented with said pair of rods;
said member is positioned in a respective one of said plurality of notches in said rounded surface of said car seat base when said pair of seat handles is in said first position such that said member inhibits said car seat base from being pivoted in said top section of said mounting base; and
said member is urged downwardly out of said respective notch in said rounded surface when either of said pair of seat handles is urged into said second position thereby enabling said car seat base to be pivoted in said top section of said mounting base.

10. The device according to claim 9, wherein:
said car seat locking mechanism includes a pair of supports;
each of said pair of support includes a lower section which slidably receives a second section such that each of said pair of supports has a telescopically adjustable height;
said upper section of each of said pair of support is biased to extend upwardly from said lower section of a respective support;
said lower section of each of said pair of supports is attached to said bottom wall of said top section of said mounting base such that each of said pair of supports is positioned within said top section;
said upper section of each of said pair of supports is attached to a respective one of said pair of rods;
said upper section of each of said supports is compressed downwardly into said lower section of a respective support when either of said pair of seat handles is urged into said second position; and
said upper section of each of said supports biases said respective rod upwardly thereby positioning said member in a respective one of said plurality of notches in said rounded surface of said car seat base when said pair of seat handles is biased into said first position.

11. The device according to claim 7, wherein:
said car seat locking mechanism includes a plurality of biasing members;
each of said plurality of biasing members of said car seat locking mechanism is positioned between a respective one of said pair of pins on respective one of said pair of seat handles and a lower bounding surface of said respective first recess and said second recess;
each of said plurality of biasing members of said car seat locking mechanism biases said respective seat handle into a first position having said lower surface of each of said pair seat handles being spaced upwardly from said lower bounding surface of said respective first recess or said second recess; and
each of said pair of seat handles is urgeable downwardly into a second position having said lower surface of said pair of seat handles travelling toward said lower bounding surface of said respective first recess or said second recess.

12. A tiltable child seat device for enabling a mother to breastfeed a child while the mother and child are seated in a vehicle, said device comprising:
a mounting base comprising a top section being rotatably attached to a bottom section such that said top section is rotatable about a vertical axis on said bottom section, said bottom section of said mounting base being positionable on a seat in a vehicle having said top section extending upwardly from the seat, said top section having a plurality of outer surfaces being perpendicularly oriented with each other such that said top section has a rectilinear shape, said bottom section having an outer surface being continuously arcuate such that said bottom section has a circular shape wherein said mounting base is configured to facilitate a mother to sit next to said bottom section without having said outer surfaces of said top section striking the mother's leg when said top section is rotated, said mounting base having a plurality of stops, said bottom section having a top side being open, said mounting base including a disk being rotatably positioned within said bottom section such that an upper surface of said disk is aligned with said top side of said bottom section, said disk having a lip extending outwardly from an outside surface of said disk which is aligned with a lower surface of said disk, said lip extending into a groove which is integrated into said bottom section thereby inhibiting said disk from being lifted outwardly from said bottom section, said disk having a plurality of notches each extending into an exterior surface of said disk such that said plurality of notches defines said plurality of stops, said plurality of notches being evenly spaced apart from each other and being distributed partially around a circumference of said disk, said bottom section having a recess extending into said outer surface of said bottom section, said top section having a bottom wall being attached to said upper surface of said disk, each of said plurality of outer surfaces of said top section having a length which is greater than a diameter of said bottom section such that an intersection between respective outer surfaces of said top section extends outwardly beyond said outer surface of said bottom section, said top section having an upper end being open into an interior of said top section, said plurality of outer surfaces of said top section having a front side and a back side and a first lateral side and a second lateral side, each of said front side and said back side being scalloped to curve downwardly toward said bottom section, said top section having a first recess extending into said first lateral side of said outer surfaces of said top section, said top section having a second recess extending into said second lateral side of said outer surfaces of said top section;
a base locking mechanism being movably integrated into said bottom section of said mounting base, said base locking mechanism being biased into a locking condition having said base locking mechanism engaging a respective one of said plurality of stops in said mounting base thereby inhibiting said top section from being rotated, said base locking mechanism being urgeable into an unlocking condition having said base locking mechanism being disengaged from said plurality of stops thereby enabling said top section to be rotated, said base locking mechanism comprising:
a base handle having a first end and a second end and a forward surface and a lower surface, said lower surface curving downwardly between each of said first end and said second end wherein said lower surface is configured to enable said base handle to be gripped, said base handle having a pair of pins each being disposed on a respective one of said first end and said second end, each of said pair of pins extending into a respective one of a first lateral bounding surface and a second lateral bounding surface of said recess in said outer surface of said bottom section of said mounting base for pivotally retaining said base handle in said recess in said outer surface of said bottom section;
a pair of biasing members, each of said pair of biasing members being positioned around a respective one of said pair of pins, each of said pair of biasing members biasing said base handle into a first position having said forward surface lying on a vertical plane, said base handle being pivotable into a second position having said forward surface lying on an angled plane and having said lower surface extending outwardly from said recess in said outer surface of said bottom section of said base when said base handle is gripped; and
a finger being attached to and extending away from said forward surface, said finger engaging a respective one of said plurality of notches in said in said disk when said base handle is biased into said first position thereby inhibiting said disk from being rotated, said finger being displaced from said respective notch when said base handle is pivoted into said second position thereby enabling said disk to be rotated;
a car seat having a car seat base being pivotally disposed in said top section of said mounting base and a seat being attached to said car seat base wherein said seat is configured to accommodate a child, said car seat being pivotal in either direction in said mounting base wherein said car seat is configured to position the child at a preferred orientation to facilitate a mother to breastfeed the child while the mother is sitting next to said car seat such that the child can remain seated in said seat for enhancing safety of the child when the mother and the child are travelling in the vehicle, said car seat having a plurality of stops each being integrated into said car seat base, said car seat base having a rounded surface which extends into said top section of said mounting base, said car seat base having a series of notches each being integrated into said rounded surface such that said series of notches defines said plurality of stops in said car seat base, said car seat base having a top surface and an outside surface extending between said top surface of said car seat base and said rounded surface, said rounded surface being convexly arcuate with respect to said top surface of said car seat base, said top surface of said car seat base being planar, said outside surface of said car seat base being perpendicularly oriented with said top surface of said car seat base, said rounded surface of said car seat base having a channel being recessed into said rounded surface, said channel extending between a first lateral side and a second lateral side of said outside surface of said car seat base, said channel being oriented to bisect said rounded surface, each of said series of notches in said rounded surface extending along a line being perpendicularly oriented with said channel having each of said series of notches extending across said channel, said series of notches being spaced apart from each other and being distributed along a full length of said channel, said car seat base being oriented in said top section of said mounting base having said channel extending along a line extending between said first lateral side and said second lateral side of said outer surface of said top section, said car seat being pivotal in said top section of said mounting base along said channel, said seat of said car seat including a plurality of cushions and a securing harness wherein said car seat is configured to have the child seated on said cushions and having said securing harness extending over the child for securing the child in said seat of said car seat, said plurality of cushions including a pair of head cushions being spaced apart from each other and being located proximate a top end of said seat of said car seat wherein said pair of head cushions is configured to be positioned on either side of the child's head for inhibiting the child's head from tilting from side to side when said car seat is pivoted in said mounting base; and
a car seat locking mechanism being movably integrated into said mounting base, said car seat locking mechanism being biased into a locking condition having said car seat locking mechanism engaging a respective one of said plurality of stops in said car seat thereby inhibiting said car seat from being pivoted in said mounting base, said car seat locking mechanism being urgeable into an unlocking condition having said car seat locking mechanism being displaced from said respective stop in said car seat thereby enabling said car seat to be pivoted in said mounting base, said car seat locking mechanism comprising:
a pair of seat handles, each of said pair of seat handles having a first end and a second end and a forward surface and a lower surface, said lower surface of each of said seat handles curving downwardly between each of said first end and said second end of a respective seat handle, said seat handles having a pair of pins each being disposed on a respective one of said first end and said second end of a respective seat handle, each of said pair of pins of said seat handles extending into a respective one of a first lateral bounding surface and a second lateral bounding surface of a respective one of said first recess and said second recess outer surface of said top section of said mounting base for slidably retaining said seat handles in said respective first recess and second recess wherein one of said pair of seat handles is configured to be accessible to the mother regardless of which side of said car seat the mother is situated;
a plurality of biasing members, each of said plurality of biasing members of said car seat locking mechanism being positioned between a respective one of said pair of pins on respective one of said pair of seat handles and a lower bounding surface of said respective first recess and said second recess, each of said plurality of biasing members of said car seat locking mechanism biasing said respective seat handle into a first position having said lower surface of each of said pair seat handles being spaced upwardly from said lower bounding surface of said respective first recess or said second recess, each of said pair of seat handles being urgeable downwardly into a second position having said lower surface of said pair of seat handles travelling toward said lower bounding surface of said respective first recess or said second recess;
a pair of rods, each of said pair of rods having a primary end being coupled to said forward surface of a respective one of said pair of seat handles having each of said pair of rods being positioned in said top section of said mounting base, each of said pair of rods being oriented to angle downwardly from said forward surface of said respective seat handle having each of said pair of rods extending through said channel in said rounded surface of said car seat base thereby inhibiting said pair of rods from abutting said car rounded surface of said car seat base when said pair of seat handles are biased into said first position, a secondary end of each of said pair of rods being centrally located in said top section of said mounting base;
a member being attached to said secondary end of each of said pair of rods such that said member is perpendicularly oriented with said pair of rods, said member being positioned in a respective one of said plurality of notches in said rounded surface of said car seat base when said pair of seat handles is in said first position such that said member inhibits said car seat base from being pivoted in said top section of said mounting base, said member being urged downwardly out of said respective notch in said rounded surface when either of said pair of seat handles is urged into said second position thereby enabling said car seat base to be pivoted in said top section of said mounting base; and
a pair of supports, each of said pair of support including a lower section which slidably receives a second section such that each of said pair of supports has a telescopically adjustable height, said upper section of each of said pair of support being biased to extend upwardly from said lower section of a respective support, said lower section of each of said pair of supports being attached to said bottom wall of said top section of said mounting base such that each of said pair of supports is positioned within said top section, said upper section of each of said pair of supports being attached to a respective one of said pair of rods, said upper section of each of said supports being compressed downwardly into said lower section of a respective support when either of said pair of seat handles is urged into said second position, said upper section of each of said supports biasing said respective rod upwardly thereby positioning said member in a respective one of said plurality of notches in said rounded surface of said car seat base when said pair of seat handles is biased into said first position.
